(19) United States
(12) Patent Application Publication
(10) Pub. No.: US 2015/0306856 A1
(43) Pub. Date: Oct. 29, 2015

(54) METHOD OF MANUFACTURING MACHINE-LAMINATED BASKETBALL

(71) Applicant: YUAN CHI SPORTS ENTERPRISE CO., LTD., Taipei (TW)

(72) Inventor: Chun-Nan LIN, Taipei (TW)

(21) Appl. No.: 14/506,066

(22) Filed: Oct. 3, 2014

(30) Foreign Application Priority Data
Apr. 24, 2014 (CN) 201410168746.3

(51) Int. Cl. B32B 37/10

(52) U.S. Cl. CPC B32B 37/10

(57) ABSTRACT

A method for manufacturing a machine-laminated basketball comprises the steps of: providing a winding on a bladder; providing a carcass; forming a first adhesive layer on the carcass, drying the first adhesive layer; providing a second adhesive layer on each of multiple ball covers, drying the second adhesive layer; arranging the ball covers in two hemisphere molds; placing the carcass in one of the two hemisphere molds; closing up the two hemisphere molds; inflating the carcass to obtain a pre-laminated ball; vulcanizing the pre-laminated ball to obtain a vulcanized laminated ball; surface finishing the vulcanized laminated ball, and painting strips to obtain the machine-laminated basketball. Accordingly, the ball covers of the basketball are firmly laminated to the carcass. Basketballs made by the method have a unified rebound and appearance can be varied depending on demand. The method has an improved production efficiency.

### CROSS-REFERENCE TO RELATED APPLICATION

This application is based upon and claims priority under 35 U.S.C. 119(a) from China Patent Application No. 201410168746.3 filed on Apr. 24, 2014, which is hereby specifically incorporated herein by this reference thereto.

### BACKGROUND OF THE INVENTION

1. Field of the Invention

The present invention relates to a method of manufacturing a laminated basketball, especially to a method of manufacturing a machine-laminated basketball.

2. Description of the Prior Art(s)

A laminated basketball has a carcass, multiple ball covers, and a valve. The carcass has a bladder, a fabric winding, and a rubber sheet. The bladder is located at the center of the laminated basketball and is the core of basketball. The fabric winding winds the bladder. The rubber sheet is located at the outer side of the winding. The ball covers are located at the outer side of the carcass; that is, located on the rubber sheet of the carcass. Generally, the bladder and the rubber sheet are made of black rubber. The ball covers are made of synthetic leather, which is reinforcing fibers, polyurethane or polyvinylchloride, or corium. The valve is used to inflate or deflate the bladder.

Conventionally, to manufacture the laminated basketball, the ball covers are manually laminated on the carcass. As a skilled technician requires sufficient training and labor cost is on the rise, the laminating efficiency of the ball covers is hard to have break-through improvement, and laminating of the ball covers has been operated by a machine.

However, a conventional method of manufacturing a machine-laminated basketball is vulcanizing and molding the carcass first to obtain a vulcanized carcass. Then a lot of time is spent on surface finishing the vulcanized carcass to obtain a surface finished carcass. In detail, the surface finishing of the vulcanized carcass includes surface roughening, burr removing, dust removing, and washing. After the vulcanized carcass is surface roughened, the burr of the vulcanized carcass is removed; then the dust on the vulcanized carcass formed after the surface roughening and burr removing is removed. After dust removing, the vulcanized carcass is washed by cleaning agents to obtain the surface finished carcass. Afterwards, a number of ball covers are laminated on the surface finished carcass simultaneously by a laminating machine. Hence, the manufacturing efficiency of the conventional method of manufacturing the laminated basketball by machine is not high enough.

In addition, since the carcass is vulcanized and molded first, a number of ball covers on the laminated basketball is determined by a mold used in the vulcanizing and molding of the carcass ball covers. Therefore, the number of the ball covers laminated is limited after the carcass is vulcanized and molded.

Also, the texture pattern on the outer surface of each of the ball covers depends on facility of the manufacturer of the ball covers, so the appearance of the laminated basketball thus produced is monotonous.

China Patent publication No. 100491101 C provides a manufacturing technology of a machine-laminated basketball and its specified mold. According to said patent publication, a graft chloroprene adhesive is coated on the surface of a vulcanized carcass. A number of ball covers and a number of strips are placed in a mold of the machine and laminated on the carcass via the graft chloroprene adhesive simultaneously by machine. Each of the strips is located between two adjacent ones of the ball covers and is made of rubber. Each of the strips is used to shield the clearance between two adjacent ball covers.

However, the mold applied to laminate the ball covers and the strips is specified. In detail, to laminate the strips, the mold has an amount of grooves for accommodating the strips. In addition, since the ball covers is hard to be uniform in thickness and the ball covers and the strips are laminated, gaps are prone to exist between the strips and the ball covers and the edge of the ball covers that connected to the strips are prone to be uneven.

Based on the above, the conventional methods of manufacturing a machine-laminated basketball have the problems that the edge of the ball covers connecting to the strips are prone to be uneven, the number of the ball covers laminated is limited after the carcass is vulcanized and molded, and the appearance of the laminated basketball thus manufactured is monotonous.

To overcome the shortcomings, the present invention provides a method of manufacturing a machine-laminated basketball to mitigate or obviate the aforementioned problems.

### SUMMARY OF THE INVENTION

The main objective of the present invention is to provide a method of manufacturing a machine-laminated basketball. The method manufactures the machine-laminated basketball that has evenly and firmly laminated ball covers on the carcass without laminating the strips.

The method in accordance with the present invention comprises steps of:

(a): winding a fabric on a surface of a bladder to obtain a winding;

(b): adhering a rubber sheet on the winding and wrapping the winding by the rubber sheet to obtain a carcass;

(c): coating a first adhesive on an outer surface of the carcass to obtain a first adhesive layer on the carcass;

(d): drying the first adhesive layer;

(e): coating a second adhesive on an inner surface of each of multiple ball covers to obtain a second adhesive layer on each of the ball covers;

(f): drying the second adhesive layer;

(g): arranging and vacuuming the ball covers against inner surfaces of two hemisphere molds;

(h): placing the carcass in one of the two hemisphere molds;

(i): closing up the two hemisphere molds to form a sphere;

(j): inflating the carcass to pre-laminate the ball covers on the carcass via the first adhesive layer and the second adhesive layers, so as to obtain a pre-laminated ball;

(k): vulcanizing the pre-laminated ball in a vulcanization mold, and obtaining a vulcanized laminated ball; and

(l): surface finishing the vulcanized laminated ball and painting or coating strips on ball covers to obtain the machine-laminated basketball.

Based on the above, comparing with conventional methods, the method of manufacturing the machine-laminated basketball in accordance with the present invention has advantages as follows.

Firstly, the ball covers are laminated to the carcass simultaneously with vulcanization of the carcass after the ball covers are pre-laminated to the carcass, so the ball covers are firmly laminated to the carcass.

Secondly, as the strips are painted or coated on ball covers instead of being laminated, no gap is prone to exist between the strips and the ball covers and the zones of the ball covers near or connected to the strips are even. Also, since the strips are painted, instead of being made of rubber, when the ball covers are made of same species of synthetic leather, machine-laminated basketballs made by the method can have a unified rebound.

Thirdly, in the step of vulcanizing the pre-laminated ball in the vulcanization mold, depending on demand, the vulcanization mold is allowed to have some ridges or grooves to form texture pattern on the outer surfaces of the ball covers different from the original texture pattern, so the appearance of the machine-laminated basketball manufactured by the method in accordance with the present invention can be diverse and meets market demand.

Fourthly, the production efficiency of the method in accordance with the present invention is improved. On one hand, since the ball covers are laminated to the carcass simultaneously with the vulcanization of the carcass after the ball covers are pre-laminated to the carcass, the surface finishing process of a vulcanized carcass before laminating ball covers is omitted

On the other hand, by utilizing a vulcanization mold having some suitable ridges, the appearance of the machine-laminated basketball obtained by the method in accordance with the present invention visually appears to have more ball covers than it really has; that is, the amount of the ball covers really used is less than it looks from the appearance of the machine-laminated basketball. As the amount of the ball covers used is reduced, the efficiency of laminating the ball covers is increased, and the method in accordance with the present invention has improved production efficiency.

Preferably, in accordance with the method of the present invention, step d comprises: drying the first adhesive layer at 35° C. to 50° C. for 3 minutes to 5 minutes.

Preferably, in accordance with the method of the present invention, the step f comprises: drying the second adhesive layer at 35° C. to 50° C. for 3 minutes to 5 minutes.

Preferably, in accordance with the method of the present invention, the number of the ball covers ranges from 2 to 12.

Preferably, in accordance with the method of the present invention, step j comprises: inflating the carcass under an inflation pressure of 0.6 MPa to 1.0 MPa for an inflation period of 4 seconds to 8 seconds to pre-laminate the ball covers to the carcass via the first adhesive layer and the second adhesive layers, and obtaining the pre-laminated ball.

Preferably, in accordance with the method of the present invention, the step k comprises: vulcanizing the carcass and laminating the ball covers to the carcass at 150° C. to 170° C. for 7 minutes to 9 minutes in the vulcanization mold, and obtaining the vulcanized laminated ball.

Preferably, in accordance with the method of the present invention, the step j comprises the steps of: inflating carcass to pre-laminate the ball covers on the carcass via the first adhesive layer and the second adhesive layers; and laminating a transfer printing paper having a mark on the ball covers to obtain the pre-laminated ball; and the step k comprises the steps of: vulcanizing the carcass and laminating the ball covers to the carcass in a vulcanization mold; and peeling off the transfer printing paper and leaving the mark on the ball covers to obtain the vulcanized laminated ball.

More preferably, in accordance with the method of the present invention, the step j comprises the steps of: inflating carcass under an inflation pressure of 0.6 MPa to 1.0 MPa for an inflation period of 4 to 8 seconds to pre-laminate the ball covers on the carcass via the first adhesive layer and the second adhesive layers; and laminating a transfer printing paper having a mark on the ball covers to obtain the pre-laminated ball; and the step k comprises the steps of: vulcanizing the carcass and laminating the ball covers to the carcass at 150° C. to 170° C. for 7 minutes to 9 minutes in a vulcanization mold; and peeling off the transfer printing paper and leaving the mark on the ball covers to obtain the vulcanized laminated ball.

With the elevated temperature to vulcanize the carcass and laminate the ball covers to the carcass, the mark is firmly laminated to the ball covers after the transfer printing paper is peeled off.

Other objectives, advantages, and novel features of the invention will become more apparent from the following detailed description when taken in conjunction with the accompanying drawings.

### BRIEF DESCRIPTION OF THE DRAWINGS

FIG. 1 is a flow diagram of a method of manufacturing a machine-laminated basketball in accordance with the present invention.

### DETAILED DESCRIPTION OF THE PREFERRED EMBODIMENTS

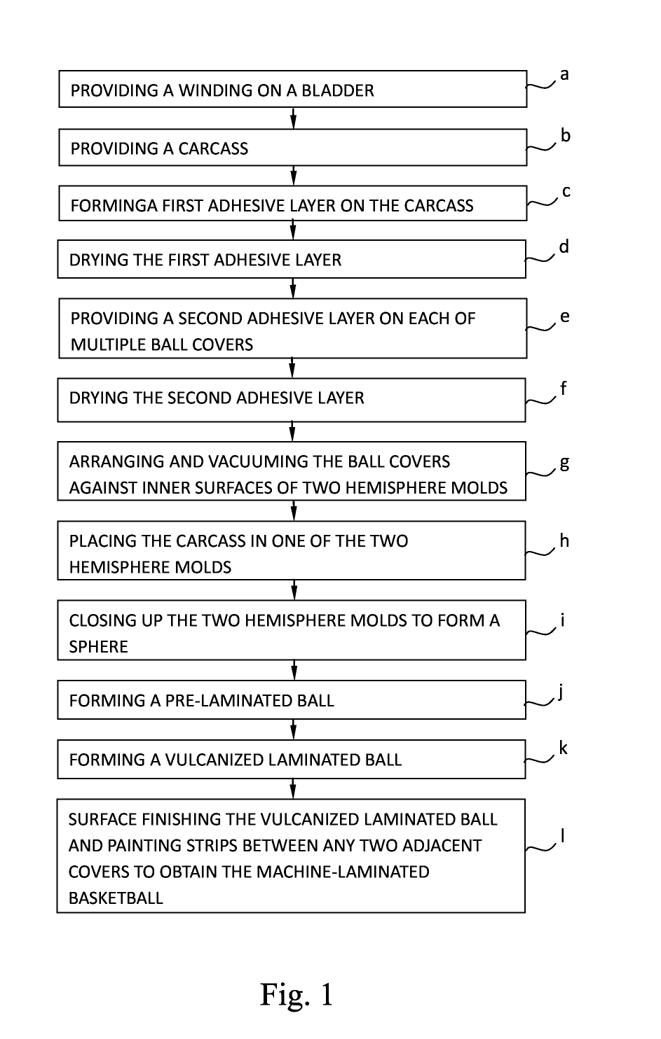

With reference to FIG. 1, a method of manufacturing a machine-laminated basketball is as follows.

Step a: A fabric is winded on a surface of a bladder and a winding on the bladder is obtained.

Step b: A rubber sheet is adhered on the winding and wraps the winding to obtain a carcass.

Step c: A first adhesive is coated on an outer surface of the carcass and a first adhesive layer is obtained on the carcass.

Step d: The first adhesive layer is dried at 35° C. to 50° C. for 3 minutes to 5 minutes.

Step e: A second adhesive is coated on an inner surface of each of multiple ball covers and a second adhesive layer on each of the ball covers is obtained.

Step f: The second adhesive layer is dried at 35° C. to 50° C. for 3 minutes to 5 minutes.

Step g: The ball covers are arranged and vacuumed against inner surfaces of two hemisphere molds of a cover laminating machine. The number of the ball covers ranges from 2 to 12 and the ball covers are arranged to wrap the whole surface of the carcass after the two hemisphere molds are closed up to form a sphere.

When the number of the ball covers is 2, the ball covers are hemispheres in shape. As the larger the sizes of the ball covers are, the fewer the number of the ball covers arranged and vacuumed against inner surfaces of two hemisphere molds is; thereby the efficiency of laminating the ball covers is improved.

Step h: The carcass is placed in one of the two hemisphere molds.

Step i: The two hemisphere molds are closed up to form a sphere.

Step j: The carcass is inflated under an inflation pressure of 0.6 MPa to 1.0 MPa for an inflation period of 4 seconds to 8 seconds to pre-laminate the ball covers to the carcass via the first adhesive layer and the second adhesive layers; then a transfer printing paper having a mark is laminated on the ball covers and a pre-laminated ball is obtained.

Step k: After the pre-laminated ball is placed in a vulcanization mold of a vulcanizing machine to vulcanize the carcass and firmly laminate the ball covers to the carcass at 150° C. to 170° C. for 7 minutes to 9 minutes, the transfer printing paper is peeled off, leaving the mark printed on the ball covers; then a vulcanized laminated ball is obtained.

As the ball covers are pre-laminated to the carcass, during vulcanization of the carcass, the ball covers are allowed to be further firmly laminated to the carcass.

Since the ball covers are laminated to the carcass simultaneously with the vulcanization of the carcass after the ball covers are pre-laminated to the carcass, the surface finishing process of a vulcanized carcass before laminating ball covers is omitted. Therefore, the production efficiency of the method is improved

Step l: Surface finishing the vulcanized laminated ball and painting strips between any two adjacent ball covers to obtain the machine-laminated basketball.

Depending on demand, the vulcanization mold is allowed to have some ridges or grooves to form texture pattern on the outer surfaces of the ball covers different from the original texture pattern, so the appearance of the machine-laminated basketball manufactured by the method is diverse and meets the market demand.

Further, by utilizing a vulcanization mold having some suitable ridges to form some strip grooves on the ball covers for painting or coating strips, the appearance of the machine-laminated basketball obtained by the method visually appears to have more ball covers than it really has; that is, the amount of the ball covers really used is less than it looks from the appearance of the machine-laminated basketball. As the amount of the ball covers used is reduced, the efficiency of laminating the ball covers is increased.

Besides, since the strips are painted or coated, instead of being made from rubber, when the ball covers are made from same species of synthetic leather, the rebound of the machine-laminated basketball is unified. In addition, since the strips are painted or coated on ball covers instead of being laminated, no gap is prone to exist between the strips and the ball covers and the zones of the ball covers near or connected to the strips are even.

### EXAMPLE 1

A method of manufacturing a machine-laminated basketball of the present example was as follows.

A fabric was winded on a surface of a bladder and a winding on the bladder was obtained. A rubber sheet was adhered on the winding and wrapped the winding, and a carcass comprising the bladder, the winding, and the rubber sheet was obtained. A first adhesive was coated on an outer surface of the carcass and a first adhesive layer was obtained on the carcass. The first adhesive layer was dried at 35° C. for 3 minutes.

A second adhesive was coated on an inner surface of each of multiple ball covers and a second adhesive layer on each of the ball covers was obtained. The second adhesive layer was dried at 35° C. for 3 minutes.

The ball covers were arranged and vacuumed against inner surfaces of two hemisphere molds of a cover laminating machine. The number of the ball covers was 2. The ball covers were arranged to wrap the whole surface of the carcass after the two hemisphere molds were closed up to form a sphere. In the present example, the shapes of the ball covers were hemispheres.

The carcass was placed in one of the two hemisphere molds.

The two hemisphere molds were closed up to form a sphere.

The carcass was inflated under an inflation pressure of 0.6 MPa for an inflation time of 4 seconds to pre-laminate the ball covers on the carcass via the first adhesive layer and the second adhesive layer. After the ball covers were pre-laminated to the carcass, a transfer printing paper having a mark was laminated on the ball covers; then a pre-laminated ball was obtained.

The pre-laminated ball was placed in a vulcanization mold of a vulcanizing machine to vulcanize the carcass at around 150° C. for 7 minutes and the ball covers were firmly laminated to the carcass. Then the transfer printing paper was peeled off, leaving the mark printed on the ball covers, and a vulcanized laminated ball was obtained.

The vulcanized laminated ball was surface finished and strips were painted between any two adjacent ball covers, and the machine-laminated basketball was obtained.

### EXAMPLE 2

A method of manufacturing a machine-laminated basketball of the present example was as follows.

A fabric was winded on a surface of a bladder and a winding on the bladder was obtained. A rubber sheet was adhered on the winding and wrapped the winding, and a carcass comprising the bladder, the winding, and the rubber sheet was obtained. A first adhesive was coated on an outer surface of the carcass and a first adhesive layer was obtained on the carcass. The first adhesive layer was dried at 40° C. for 4 minutes.

A second adhesive was coated on an inner surface of each of multiple ball covers and a second adhesive layer on each of the ball covers was obtained. The second adhesive layer was dried at 40° C. for 3 minutes.

The ball covers were arranged and vacuumed against inner surfaces of two hemisphere molds of a cover laminating machine. The number of the ball covers was 8. The ball covers were arranged to wrap the whole surface of the carcass after the two hemisphere molds were closed up to form a sphere.

The carcass was placed in one of the two hemisphere molds.

The two hemisphere molds were closed up to form a sphere.

The carcass was inflated under an inflation pressure of 0.8 MPa for an inflation time of 6 seconds to pre-laminate the ball covers on the carcass via the first adhesive layer and the second adhesive layers. After the ball covers were pre-laminated to the carcass, a transfer printing paper having a mark was laminated on the ball covers; then a pre-laminated ball was obtained.

The pre-laminated ball was placed in a vulcanization mold of a vulcanizing machine to vulcanize the carcass at around 160° C. for 8 minutes and the ball covers were firmly laminated to the carcass. Then the transfer printing paper was peeled off, leaving the mark printed on the ball covers, and a vulcanized laminated ball was obtained.

The vulcanized laminated ball was surface finished and strips ware painted between any two adjacent ball covers, and the machine-laminated basketball was obtained.

### EXAMPLE 3

A method of manufacturing a machine-laminated basketball of the present example was as follows.

A fabric was winded on a surface of a bladder and a winding on the bladder was obtained. A rubber sheet was adhered on the winding and wrapped the winding, and a carcass comprising the bladder, the winding, and the rubber sheet was obtained. A first adhesive was coated on an outer surface of the carcass and a first adhesive layer was obtained on the carcass. The first adhesive layer was dried at 50° C. for 5 minutes.

A second adhesive was coated on an inner surface of each of multiple ball covers and a second adhesive layer on each of the ball covers was obtained. The second adhesive layer was dried at 50° C. in 5 minutes.

The ball covers were arranged and vacuumed against inner surfaces of two hemisphere molds of a cover laminating machine. The number of the ball covers was 12. The ball covers were arranged to wrap the whole surface of the carcass after the two hemisphere molds were closed up to form a sphere.

The carcass was placed in one of the two hemisphere molds.

The two hemisphere molds were closed up to form a sphere.

The carcass was inflated under an inflation pressure of 1 MPa for an inflation time of 8 seconds to pre-laminate the ball covers on the carcass via the first adhesive layer and the second adhesive layers. After the ball covers were pre-laminated to the carcass, a transfer printing paper having a mark was laminated on the ball covers; then a pre-laminated ball was obtained.

The pre-laminated ball was placed in a vulcanization mold of a vulcanizing machine to vulcanize the carcass at around 170° C. for 9 minutes and the ball covers were firmly laminated to the carcass. Then the transfer printing paper was peeled off, leaving the mark printed on the ball covers, and then a vulcanized laminated ball was obtained.

The vulcanized laminated ball was surface finished and strips were painted between any two adjacent ball covers, and the machine-laminated basketball was obtained.

Even though numerous characteristics and advantages of the present invention have been set forth in the foregoing description, together with details of the features of the invention, the disclosure is illustrative only. Changes may be made in the details, especially in arrangement of parts within the principles of the invention to the full extent indicated by the broad general meaning of the terms in which the appended claims are expressed.

What is claimed is:

1. A method of manufacturing a machine-laminated basketball comprising:
step a: winding a fabric on a surface of a bladder to obtain a winding on the bladder;
step b: adhering a rubber sheet on the winding and wrapping the winding by the rubber sheet to obtain a carcass;
step c: coating a first adhesive on an outer surface of the carcass to obtain a first adhesive layer on the carcass;
step d: drying the first adhesive layer;
step e: coating a second adhesive on an inner surface of each of multiple ball covers to obtain a second adhesive layer on each of the ball covers;
step f: drying the second adhesive layer;
step g: arranging and vacuuming the ball covers against inner surfaces of two hemisphere molds;
step h: placing the carcass in one of the two hemisphere molds;
step i: closing up the two hemisphere molds to form a sphere;
step j: inflating the carcass to pre-laminate the ball covers on the carcass via the first adhesive layer and the second adhesive layers, so as to obtain a pre-laminated ball;
step k: vulcanizing the carcass and laminating the ball covers to the carcass in a vulcanization mold, and obtaining a vulcanized laminated ball; and
step l: surface finishing the vulcanized laminated ball and painting strips between any two adjacent ball covers to obtain the machine-laminated basketball.

2. The method as claimed in claim 1, wherein the step j comprises the steps of:
inflating the carcass to pre-laminate the ball covers on the carcass via the first adhesive layer and the second adhesive layers; and
laminating a transfer printing paper having a mark on the ball covers to obtain the pre-laminated ball; and
the step k comprises the steps of:
vulcanizing the carcass and laminating the ball covers to the carcass in a vulcanization mold; and
peeling off the transfer printing paper and leaving the mark printed on the ball covers to obtain the vulcanized laminated ball.

3. The method as claimed in claim 2, wherein the step j comprises the steps of:
inflating the carcass under an inflation pressure of 0.6 MPa to 1.0 MPa for an inflation period of 4 seconds to 8 seconds to pre-laminate the ball covers on the carcass via the first adhesive layer and the second adhesive layers; and
laminating the transfer printing paper having a mark on the ball covers to obtain the pre-laminated ball; and
the step k comprises the steps of:
vulcanizing the carcass and laminating the ball covers to the carcass at 150° C. to 170° C. for 7 minutes to 9 minutes in the vulcanization mold; and
peeling off the transfer printing paper and leaving the mark printed on the ball covers to obtain the vulcanized laminated ball.

4. The method as claimed in claim 1, wherein the step d comprises: drying the first adhesive layer at 35° C. to 50° C. for 3 minutes to 5 minutes.

5. The method as claimed in claim 3, wherein the step d comprises: drying the first adhesive layer at 35° C. to 50° C. for 3 minutes to 5 minutes.

6. The method as claimed in claim 1, wherein the step f comprises: drying the second adhesive layer at 35° C. to 50° C. for 3 minutes to 5 minutes.

7. The method as claimed in claim 3, wherein the step f comprises: drying the second adhesive layer at 35° C. to 50° C. for 3 minutes to 5 minutes.

8. The method as claimed in claim 5, wherein the step f comprises: drying the second adhesive layer at 35° C. to 50° C. for 3 minutes to 5 minutes.

9. The method as claimed in claim 1, wherein a number of the ball covers ranges from 2 to 12.

10. The method as claimed in claim 3, wherein a number of the ball covers ranges from 2 to 12.

11. The method as claimed in claim 8, wherein a number of the ball covers ranges from 2 to 12.

12. The method as claimed in claim 1, wherein the step j comprises: inflating the carcass under an inflation pressure of 0.6 MPa to 1.0 MPa for an inflation period of 4 seconds to 8 seconds to pre-laminate the ball covers on the carcass via the first adhesive layer and the second adhesive layers, and obtaining the pre-laminated ball.

13. The method as claimed in claim 4, wherein the step j comprises: inflating the carcass under an inflation pressure of 0.6 MPa to 1.0 MPa for an inflation period of 4 seconds to 8 seconds to pre-laminate the ball covers on the carcass via the first adhesive layer and the second adhesive layers, so as to obtain the pre-laminated ball.

14. The method as claimed in claim 6, wherein the step j comprises: inflating the carcass under an inflation pressure of 0.6 MPa to 1.0 MPa for an inflation period of 4 seconds to 8 seconds to pre-laminate the ball covers on the carcass via the first adhesive layer and the second adhesive layers, so as to obtain the pre-laminated ball.

15. The method as claimed in claim 9, wherein the step j comprises: inflating the carcass under an inflation pressure of 0.6 MPa to 1.0 MPa for an inflation period of 4 seconds to 8 seconds to pre-laminate the ball covers on the carcass via the first adhesive layer and the second adhesive layers, so as to obtain the pre-laminated ball.

16. The method as claimed in claim 1, wherein the step k comprises: vulcanizing the carcass and laminating the ball covers to the carcass at 150° C. to 170° C. for 7 minutes to 9 minutes in the vulcanization mold, and obtaining the vulcanized laminated ball.

17. The method as claimed in claim 4, wherein the step k comprises: vulcanizing the carcass and laminating the ball covers to the carcass at 150° C. to 170° C. for 7 minutes to 9 minutes in the vulcanization mold, and obtaining the vulcanized laminated ball.

18. The method as claimed in claim 9, wherein the step k comprises: vulcanizing the carcass and laminating the ball covers to the carcass at 150° C. to 170° C. for 7 minutes to 9 minutes in the vulcanization mold, and obtaining the vulcanized laminated ball.

19. The method as claimed in claim 15, wherein the step k comprises: vulcanizing the carcass and laminating the ball covers to the carcass at 150° C. to 170° C. for 7 minutes to 9 minutes in the vulcanization mold, and obtaining the vulcanized laminated ball.
